(19) United States
(12) Patent Application Publication
(10) Pub. No.: US 2015/0077281 A1
(43) Pub. Date: Mar. 19, 2015

(54) DUMP TRUCK

(71) Applicant: Komatsu Ltd., Tokyo (JP)

(72) Inventors: Jun Taniguchi, Hiratsuka-shi (JP); Tomikazu Tanuki, Fujisawa-shi (JP); Shinji Mitsuta, Hiratsuka-shi (JP); Takeshi Kurihara, Hiratsuka-shi (JP); Yukihiro Nakanishi, Hiratsuka-shi (JP); Masaomi Machida, Hiratsuka-shi (JP); Dai Tsubone, Hiratsuka-shi (JP)

(73) Assignee: KOMATSU LTD., Tokyo (JP)

(21) Appl. No.: 13/825,171

(22) PCT Filed: Sep. 19, 2012
(86) PCT No.: PCT/JP2012/073911

§ 371 Date: Mar. 20, 2013

(30) Foreign Application Priority Data
May 22, 2012 (JP) 2012-117006

(51) Int. Cl. B60R 1/00; H04N 7/18; G01S 13/02

(52) U.S. Cl. CPC B60R 1/002; G01S 13/02; H04N 7/181; B60R 2300/105; B60R 2300/303; B60R 2300/607; B60R 2300/802
USPC 342/27; 348/148

(57) ABSTRACT

A dump truck includes a vehicle body portion that includes an upper deck on which a cab is disposed and a frame which is disposed in a longitudinal direction, a vessel that is disposed above the frame, and a sixth imaging device that is disposed below the vessel at a rear end of the frame and can image the rear side of the vehicle body portion. The sixth imaging device is a wide dynamic range camera.

### FIELD

The present invention relates to a dump truck that includes a periphery monitoring system for monitoring the periphery and is used in a mine.

### BACKGROUND

Various mining machines, such as a dump truck and an excavator, operate in a working site or a quarry site of a mine. Since the width and length of a dump truck used in a mine are significantly larger than those of a general vehicle, it is difficult for an operator to check a situation around the dump truck and take in a situation around the dump truck by side view mirrors and the like. For this reason, there is proposed a device that monitors the periphery of a vehicle, as a technique that supports driving by making a driver or an operator easily take in a situation around a vehicle. As such a device for monitoring the periphery, there is, for example, a device for forming an image, which shows the periphery of a vehicle, by imaging the periphery of a vehicle by using cameras and the like mounted on the vehicle and synthesizing the obtained images (for example, Patent Literature 1).

### CITATION LIST

### Patent Literature

Patent Literature 1: Japanese Patent Application Laid-open No. 03-099952

### SUMMARY

### Technical Problem

A dump truck used in a mine forms a shadow by oneself. Since a dump truck used in a mine is very large, a difference in the contrast of light and shade between a bright portion (sunny spot), which is irradiated with sunlight, and a shadow (shady spot) that is formed by the dump truck itself is large. In this case, if an object such as a vehicle is present in the shadow formed by the dump truck, a dark portion (a black portion) of an image taken by an imaging device collapses, so that there is a possibility that the vehicle or the like present in the shadow portion may not be recognized. Since this is not considered in Patent Literature 1, there is a room for improvement.

An object of the invention is to display vehicles or other objects, which are present around a dump truck, on an image even in an environment where a difference in the contrast of light and shade is large when monitoring the periphery of the dump truck by using images taken by imaging devices.

### Solution to Problem

According to the present invention, a dump truck comprises: a vehicle body portion that includes an upper deck on which a cab is disposed and a frame which is disposed in a longitudinal direction; a vessel that is disposed above the frame; and a rear wide dynamic range camera that is disposed below the vessel at a rear end of the frame and images a rear side of the vehicle body portion.

In the present invention, it is preferable that the dump truck further comprises: a front wide dynamic range camera that is disposed on a front portion of the upper deck and images a front side of the vehicle body portion; side wide dynamic range cameras that are disposed on left and right side portions of the upper deck, respectively, and image areas between an oblique front side and the rear side of the vehicle body portion; and a monitoring control device that monitors a periphery of the vehicle body portion by using a bird's-eye image formed by combination of images obtained by the rear wide dynamic range camera, the front wide dynamic range camera, and the respective side wide dynamic range cameras.

In the present invention, it is preferable that the side wide dynamic range cameras include a first side wide dynamic range camera that images the oblique front side of the vehicle body portion, and a second side wide dynamic range camera that images an oblique rear side of the vehicle body portion.

In the present invention, it is preferable that the dump truck further comprises: a plurality of radar devices that are provided on the vehicle body portion and detect objects present in an entire peripheral range of the vehicle body portion.

According to the present invention, a dump truck comprises: a vehicle body portion that includes an upper deck on which a driver's seat is disposed and a frame which is disposed in a longitudinal direction; a vessel that is disposed above the frame; a rear wide dynamic range camera that is disposed below the vessel at a rear end of the frame and images a rear side of the vehicle body portion; a front wide dynamic range camera that is disposed on a front portion of the upper deck and images a front side of the vehicle body portion; side wide dynamic range cameras that are disposed on left and right side portions of the upper deck, respectively, and image areas between an oblique front side and the rear side of the vehicle body portion; a monitoring control device that monitors a periphery of the vehicle body portion by using a bird's-eye image formed by combination of images obtained by the rear wide dynamic range camera, the front wide dynamic range camera, and the respective side wide dynamic range cameras; and a monitor that is disposed in the cab and displays the bird's-eye image.

The invention can display vehicles or other objects, which are present around a dump truck, on an image even in an environment where a difference in the contrast of light and shade is large when monitoring the periphery of the dump truck by using images taken by imaging devices.

### BRIEF DESCRIPTION OF DRAWINGS

FIG. 1 is a perspective view illustrating a dump truck according to this embodiment.

FIG. 2 is a view illustrating the structure of a cab of the dump truck according to this embodiment.

FIG. 3 is a view illustrating a periphery monitoring system according to this embodiment.

FIG. 4 is a perspective view illustrating the dump truck on which imaging devices of the periphery monitoring system according to this embodiment are mounted.

FIG. 5 is a schematic view illustrating a bird's-eye image that is created on the basis of information on images taken by a plurality of imaging devices and areas that are imaged by a plurality of imaging devices.

FIG. 6 is a perspective view illustrating the disposition of radar devices.

FIG. 7 is a view illustrating an image converting method using a virtual projection plane.

FIG. 8 is a plan view illustrating a relation between the dump truck and a vehicle that is present around the dump truck.

FIG. 9 is a front view illustrating the relation between the dump truck and the vehicle that is present around the dump truck.

FIG. 10 is a view illustrating an example of an imaging device to which a wide dynamic range camera is applied.

FIG. 11 is a view illustrating an imaging range of the imaging device of the periphery monitoring system according to this embodiment in a height direction.

FIG. 12 is a view illustrating the imaging range of the imaging device of the periphery monitoring system according to this embodiment in the height direction.

FIG. 13 is a view illustrating the imaging ranges of the imaging devices of the periphery monitoring system according to this embodiment in the height direction.

FIG. 14 is a view illustrating a case where a vehicle moves around the dump truck.

FIG. 15 is a view illustrating a case where a vehicle moves around the dump truck.

FIG. 16 is a view illustrating a case where a vehicle moves around the dump truck.

### DESCRIPTION OF EMBODIMENTS

An embodiment of the invention will be described in detail with reference to the drawings. The invention is not limited by the content disclosed in the following embodiment. In the following description, front, rear, left, and right are terms based on an operator seated in a driver's seat. A vehicle width direction has the same meaning as a lateral direction.

<Dump Truck>

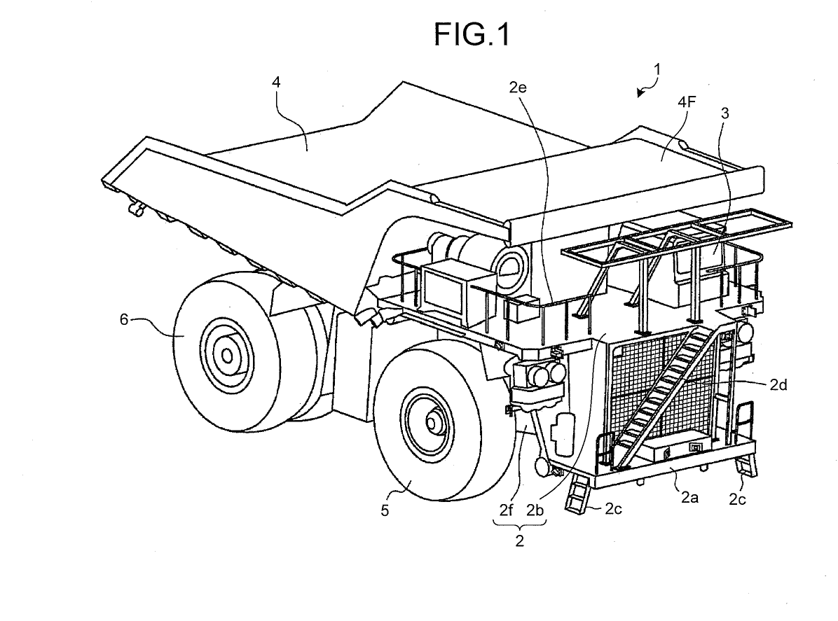

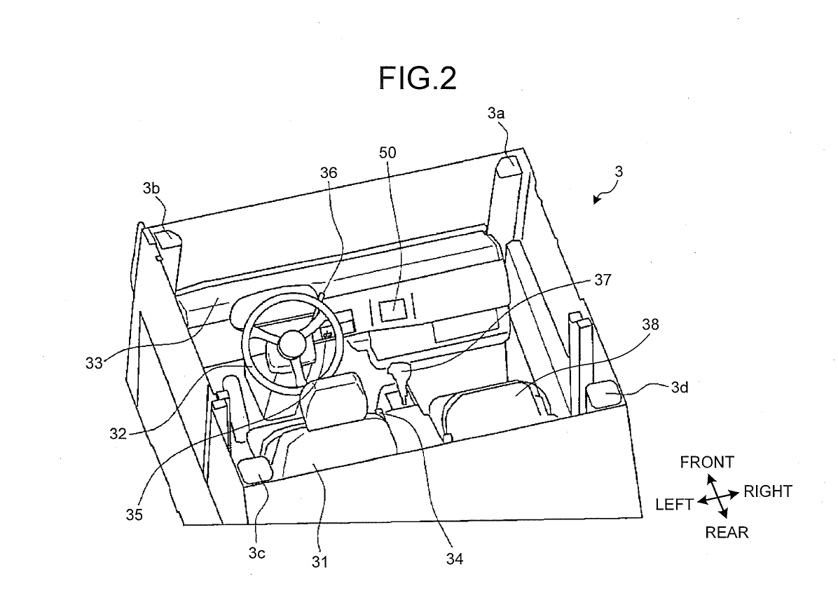

FIG. 1 is a perspective view illustrating a dump truck according to this embodiment. FIG. 2 is a view illustrating the structure of a cab of the dump truck according to this embodiment. In this embodiment, a dump truck (referred to as an off-highway truck) 1 is a self-traveling extra large vehicle that is used for a work in a mine, and the like. The dump truck 1 includes a vehicle body portion 2, a cab 3, a vessel 4, front wheels 5, and rear wheels 6. The vehicle body portion 2 includes an upper deck 2b and a frame 2f that is disposed along a longitudinal direction. Further, the dump truck 1 includes a periphery monitoring system that monitors its own peripheral area and displays the result of the monitoring. The detail of the periphery monitoring system will be described below.

In this embodiment, the dump truck 1 drives an electric motor by electric power, which is generated by the drive of a generator performed by an internal combustion engine such as a diesel engine, and drives the rear wheels 6. The dump truck 1 uses a so-called electric drive system as described above, but the drive system of the dump truck 1 is not limited thereto. For example, the dump truck 1 may transmit power of an internal combustion engine to the rear wheels 6 through a transmission in order to drive the rear wheels 6, and may drive an electric motor by power supplied from an overhead wire through a trolley in order to drive rear wheels 6 by the electric motor.

The frame 2f supports power generating mechanisms, such as an internal combustion engine and a generator, and auxiliary equipment thereof. Left and right front wheels 5 (only a right front wheel is illustrated in FIG. 1) are supported at the front portions of the frame 2f. Left and right rear wheels 6 (only a right rear wheel is illustrated in FIG. 1) are supported at the rear portion of the frame 2f. The diameter of each of the front and rear wheels 5 and 6 is about 2 to 4 m (meter). The frame 2f includes a lower deck 2a and the upper deck 2b. As described above, the dump truck 1 used in a mine has a double-deck structure that includes the lower deck 2a and the upper deck 2b.

The lower deck 2a is mounted on the lower portions of the front surface of the frame 2f. The upper deck 2b is disposed above the lower deck 2a. A movable ladder 2c, which is used when an operator climbs up to the cab 3, is disposed below the lower deck 2a. An inclined ladder 2d, which is used when an operator goes up and down between the lower deck 2a and the upper deck 2b, is disposed between the lower deck 2a and the upper deck 2b. Further, a radiator is disposed between the lower deck 2a and the upper deck 2b. A fence-like handrail 2e is disposed on the upper deck 2b. In this embodiment, the ladder 2c and the inclined ladder 2d are a part of the upper deck 2b and the lower deck 2a.

As illustrated in FIG. 1, the cab 3 is disposed on the upper deck 2b. The cab 3 is disposed on the upper deck 2b so as to be shifted to one side from the middle in the vehicle width direction. Specifically, the cab 3 is disposed on the upper deck 2b on the left side from the middle in the vehicle width direction. As illustrated in FIG. 2, the cab 3 includes a ROPS (Roll-Over Protection System) that includes a plurality of (four in this embodiment) pillars 3a, 3b, 3c, and 3d. The ROPS protects an operator present in the cab 3 if the dump truck 1 rolls over. A driver of the dump truck 1 drives the dump truck in a state where the driver can easily check the shoulder of a road that is positioned on the left side of the vehicle body portion 2. However, the driver needs to significantly move one's head in order to check the peripheral area of the vehicle body portion 2. Further, a plurality of side view mirrors (not illustrated) is provided on the upper deck 2b in order to check the peripheral area of the dump truck 1. Since these side view mirrors are disposed at the positions distant from the cab 3, the driver needs to significantly move one's head even when the driver checks the periphery of the vehicle body portion 2 with the side view mirrors.

As illustrated in FIG. 2, a driver's seat 31, a steering wheel 32, a dash cover 33, a wireless device 34, a radio receiver 35, a retarder 36, a shift lever 37, a trainer's seat 38, a controller (of which the detail will be described below) serving as a monitoring control device not illustrated in FIG. 2, a monitor 50, an accelerator pedal, a brake pedal, and the like are provided in the cab 3. Meanwhile, the controller not illustrated in FIG. 2 and the monitor 50 are a part of a periphery monitoring system 10 to be described below.

The vessel 4 illustrated in FIG. 1 is a container into which freight such as broken stone is loaded. The rear portion of the bottom of the vessel 4 is rotatably connected to the rear portion of the frame 2f by a rotating pin. The vessel 4 can take a loading posture and an upright posture by an actuator such as a hydraulic cylinder. The loading posture is a posture where the front portion of the vessel 4 is positioned above the cab 3 as illustrated in FIG. 1. The upright posture is a posture where freight is discharged, and is a posture where the vessel 4 is inclined rearward and downward. When the front portion of the vessel 4 is rotated upward, the vessel 4 is changed into the upright posture from the loading posture. The vessel 4 includes a flange portion 4F at the front thereof. The flange portion 4F extends to the upper side of the cab 3 and covers the cab 3. The flange portion 4F, which extends to the upper side of the cab 3, protects the cab 3 from the collision of broken stone and the like.

<Periphery Monitoring System>

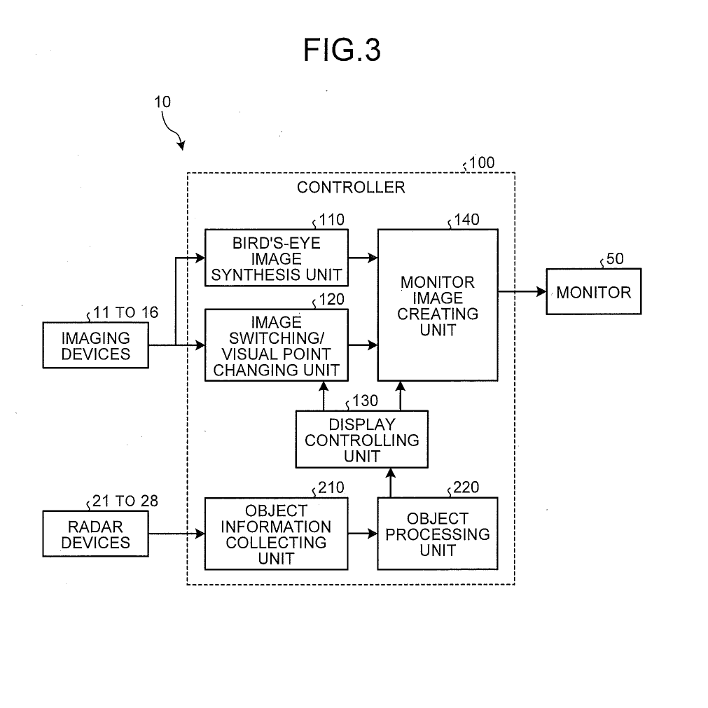

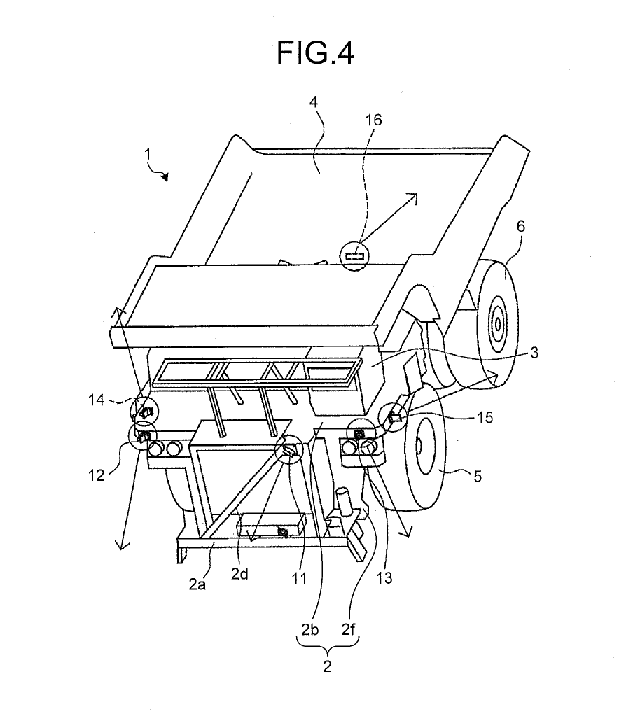

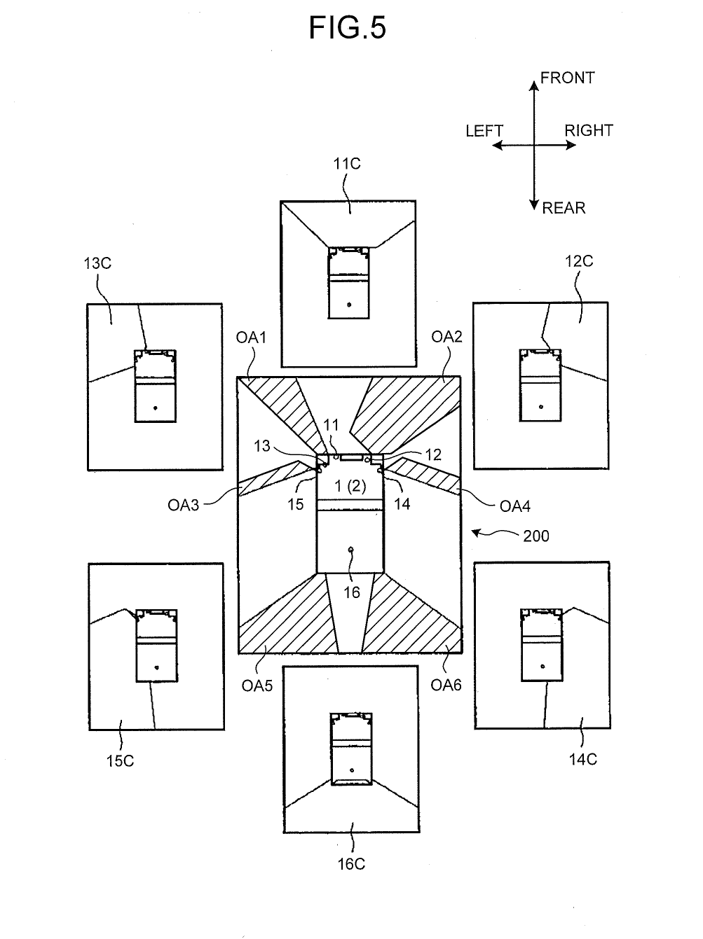

FIG. 3 is a view illustrating the periphery monitoring system according to this embodiment. FIG. 4 is a perspective view illustrating the dump truck on which imaging devices of the periphery monitoring system according to this embodiment are mounted. FIG. 5 is a schematic view illustrating a bird's-eye image that is created on the basis of information on images taken by a plurality of imaging devices and areas that are imaged by a plurality of imaging devices. Areas, which are illustrated in FIG. 5 and are imaged by a plurality of imaging device, are areas based on the ground. The periphery monitoring system 10 includes a plurality of (six in this embodiment) imaging devices 11, 12, 13, 14, 15, and 16, a plurality of (eight in this embodiment) radar devices 21, 22, 23, 24, 25, 26, 27, and 28, the monitor 50, and a controller 100 serving as a monitoring control device. Meanwhile, in this embodiment, the periphery monitoring system 10 does not necessarily require the radar devices 21, 22, 23, 24, 25, 26, 27, and 28.

<Imaging Device>

The imaging devices 11, 12, 13, 14, 15, and 16 are mounted on the dump truck 1. The imaging devices 11, 12, 13, 14, 15, and 16 are cameras using, for example, a CCD (Charge Coupled Device). The imaging devices 11, 12, 13, 14, 15, and 16 image the peripheral areas of the dump truck 1 and output the images as image information. In the following description, appropriately, the imaging device 11 is referred to as a first imaging device 11, the imaging device 12 is referred to as a second imaging device 12, the imaging device 13 is referred to as a third imaging device 13, the imaging device 14 is referred to as a fourth imaging device 14, the imaging device 15 is referred to as a fifth imaging device 15, and the imaging device 16 is referred to as a sixth imaging device 16. Further, when these do not need to be distinguished from each other, these are appropriately referred to as the imaging devices 11 to 16.

As illustrated in FIG. 4, the six imaging devices 11 to 16 are mounted on the outer peripheral portions of the dump truck 1, respectively, in order to image the range corresponding to 360° around the dump truck 1. In this embodiment, each of the imaging devices 11 to 16 has a viewing range of 120° in the lateral direction (60° on each of the right and left sides) and a viewing range of 96° in a height direction, but the viewing ranges are not limited thereto.

As illustrated in FIG. 4, the first imaging device 11 is mounted on the front surface of the dump truck 1. Specifically, the first imaging device 11 is disposed at the upper end portion of the inclined ladder 2d, more specifically, at the lower portion of the top landing portion. The first imaging device 11 is fixed by a bracket, which is mounted on the upper deck 2b, so as to face the front side of the dump truck 1. As illustrated in FIG. 5, the first imaging device 11 images a first area 11C of areas present around the dump truck 1 and outputs first image information serving as image information. The first area 11C is an area that spreads out to the front side of the vehicle body portion 2 of the dump truck 1.

As illustrated in FIG. 4, the second imaging device 12 is mounted on one side portion of the front surface of the dump truck 1. Specifically, the second imaging device 12 is disposed on the right side portion of the front surface of the upper deck 2b. The second imaging device 12 is fixed by a bracket, which is mounted on the upper deck 2b, so as to face the oblique front right side of the dump truck 1. As illustrated in FIG. 5, the second imaging device 12 images a second area 12C of areas present around the dump truck 1 and outputs second image information serving as image information. The second area 12C is an area that spreads out to the oblique front right side of the vehicle body portion 2 of the dump truck 1.

As illustrated in FIG. 4, the third imaging device 13 is mounted on the other side portion of the front surface of the dump truck 1. Specifically, the third imaging device 13 is disposed on the left side portion of the front surface of the upper deck 2b. Further, the third imaging device 13 is disposed so as to be symmetrical to the second imaging device 12 with respect to an axis that passes through the middle of the dump truck 1 in a width direction. The third imaging device 13 is fixed by a bracket, which is mounted on the upper deck 2b, so as to face the oblique front left side of the dump truck 1. As illustrated in FIG. 5, the third imaging device 13 images a third area 13C of areas present around the dump truck 1 and outputs third image information serving as image information. The third area 13C is an area that spreads out to the oblique front left side of the vehicle body portion 2 of the dump truck 1.

As illustrated in FIG. 4, the fourth imaging device 14 is mounted on one side surface of the dump truck 1. Specifically, the fourth imaging device 14 is disposed on the front portion of the right side surface of the upper deck 2b. The fourth imaging device 14 is fixed by a bracket, which is mounted on the upper deck 2b, so as to face the oblique rear right side of the dump truck 1. As illustrated in FIG. 5, the fourth imaging device 14 images a fourth area 14C of areas present around the dump truck 1 and outputs fourth image information serving as image information. The fourth area 14C is an area that spreads out to the oblique rear right side of the vehicle body portion 2 of the dump truck 1.

As illustrated in FIG. 4, the fifth imaging device 15 is mounted on the other side surface of the dump truck 1. Specifically, the fifth imaging device 15 is disposed on the front portion of the left side surface of the upper deck 2b. Further, the fifth imaging device 15 is disposed so as to be symmetrical to the fourth imaging device 14 with respect to an axis that passes through the middle of the dump truck 1 in the width direction. As illustrated in FIG. 5, the fifth imaging device 15 images a fifth area 15C of areas present around the dump truck 1 and outputs fifth image information serving as image information. The fifth area 15C is an area that spreads out to the oblique rear left side of the vehicle body portion 2 of the dump truck 1.

As illustrated in FIG. 4, the sixth imaging device 16 is mounted on the rear portion of the dump truck 1. Specifically, the sixth imaging device 16 is disposed on the rear end of the frame 2f above an axle housing, which connects two rear wheels 6 and 6, near a rotating shaft of the vessel 4. The sixth imaging device 16 is fixed by a bracket, which is mounted on a cross bar connecting the left and right portions of the frame 2f, so as to face the rear side of the dump truck 1. As illustrated in FIG. 5, the sixth imaging device 16 images a sixth area 16C of areas present around the dump truck 1 and outputs sixth image information serving as image information. The sixth area 16C is an area that spreads out to the rear side of the vehicle body portion 2 of the dump truck 1.

The periphery monitoring system 10 according to this embodiment can acquire image information by imaging the entire peripheral area, which corresponds to 360°, of the dump truck 1 with the above-mentioned six imaging devices 11 to 16 as illustrated at the center of FIG. 5. The six imaging devices 11 to 16 send the first to sixth image information, which serve as the image information acquired by the respective imaging devices, to the controller 100 illustrated in FIG. 3.

The first imaging device 11, the second imaging device 12, the third imaging device 13, the fourth imaging device 14, and the fifth imaging device 15 are provided on the upper deck 2b that is at a relatively high position. For this reason, the controller 100 can obtain images, which are obtained when a driver looks down upon the ground from above, by the first to fifth imaging devices 11 to 15, and can extensively image objects such as vehicles present on the ground. Further, even though a visual point is changed when a bird's-eye image 200 is created from the first to sixth image information acquired by the first to sixth imaging devices 11 to 16, the controller 100 can suppress the degree of the deformation of a three-dimensional object since the first to fifth image information among them are information that are obtained when an image is taken from above.

<Radar Device>

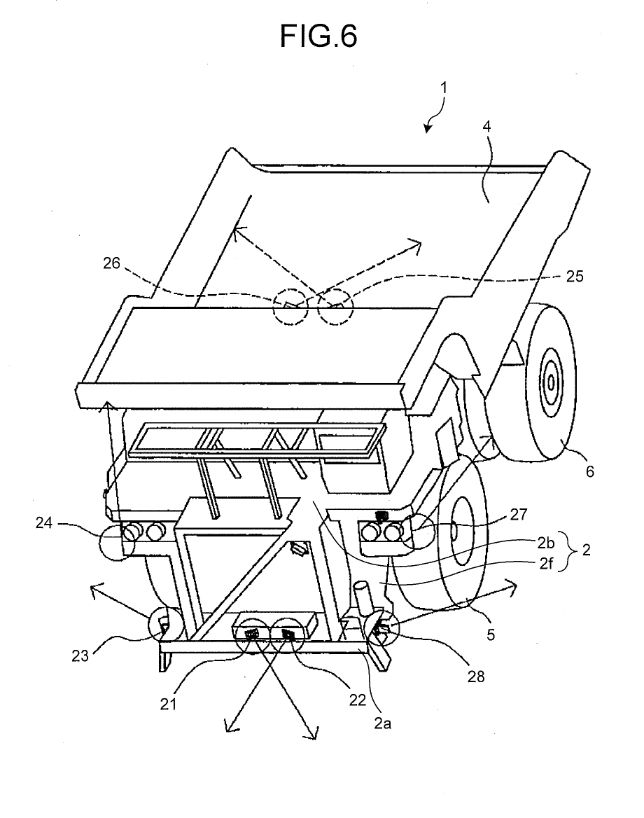

FIG. 6 is a perspective view illustrating the disposition of the radar devices. In this embodiment, each of the radar devices 21, 22, 23, 24, 25, 26, 27, and 28 (hereinafter, appropriately referred to as radar devices 21 to 28) is a UWB (Ultra Wide Band) radar (Ultra Wide Band radar) of which the range corresponds to ±80° (40° on each of the right and left sides) and a detection distance is a maximum of 15 m or more. The radar devices 21 to 28 detect relative positions between objects, which are present around the dump truck 1, and the dump truck 1. Like the imaging devices 11 to 16, the radar devices 21 to 28 are mounted on the outer peripheral portions of the dump truck 1.

As illustrated in FIG. 6, the radar device 21 (appropriately referred to as a first radar device 21) is disposed on the front surface of the vehicle body portion 2 at the lower deck 2a, which is disposed at a height of about 1 m from the ground, slightly on the right side from the middle of the vehicle body portion 2 in the width direction. The detection range of the first radar device 21 is a range that spreads out to the oblique front left side from the front side of the vehicle body portion 2 of the dump truck 1.

As illustrated in FIG. 6, the radar device 22 (appropriately referred to as a second radar device 22) is disposed on the front surface of the vehicle body portion 2 at the lower deck 2a slightly on the left side from the middle of the vehicle body portion 2 in the width direction. That is, the second radar device 22 is disposed on the left side of the first radar device 21 so as to be adjacent to the first radar device 21. The detection range of the first radar device 21 is a range that spreads out to the oblique front right side from the front side of the vehicle body portion 2 of the dump truck 1.

As illustrated in FIG. 6, the radar device 23 (appropriately referred to as a third radar device 23) is disposed near the front end portion of the right side surface of the lower deck 2a. The detection range of the third radar device 23 is a range that spreads out to the right side from the oblique front right side of the vehicle body portion 2 of the dump truck 1.

As illustrated in FIG. 6, the radar device 24 (appropriately referred to as a fourth radar device 24) is disposed near the right end portion of the side portion of the vehicle body portion 2 at an intermediate height position between the lower deck 2a and the upper deck 2b. The detection range of the fourth radar device 24 is a range that spreads out to the rear side from the right side of the vehicle body portion 2 of the dump truck 1.

As illustrated in FIG. 6, the radar device 25 (appropriately referred to as a fifth radar device 25) is disposed below the vessel 4 above an axle that transmits a drive force to the left and right rear wheels 6 of the dump truck 1. The detection range of the fifth radar device 25 is a range that spreads out to the rear side from the oblique rear right side of the vehicle body portion 2 of the dump truck 1.

As illustrated in FIG. 6, the radar device 26 (appropriately referred to as a sixth radar device 26) is disposed above the axle like the fifth radar device 25 and on the right side of the fifth radar device 25 so as to be adjacent to the fifth radar device 25. The detection range of the sixth radar device 26 is a range that spreads out to the rear side from the oblique rear left side of the vehicle body portion 2 of the dump truck 1 so as to cross the detection range of the fifth radar device 25.

As illustrated in FIG. 6, the radar device 27 (appropriately referred to as a seventh radar device 27) is disposed near the left end portion of the side surface of the vehicle body portion 2 at an intermediate height position between the lower deck 2a and the upper deck 2b, that is, at a position that is symmetrical to the fourth radar device 24 with respect to the center axis of the vehicle body portion 2 in the width direction. The detection range of the seventh radar device 27 is a range that spreads out to the rear side from the left side of the vehicle body portion 2 of the dump truck 1.

As illustrated in FIG. 6, the radar device 28 (appropriately referred to as a first radar device 28) is disposed near the front end portion of the left side surface of the lower deck 2a, that is, at a position that is symmetrical to the third radar device 23 with respect to the center axis of the vehicle body portion 2 in the width direction. The detection range of the eighth radar device 28 is a range that spreads out to the oblique front left side from the left side of the vehicle body portion 2 of the dump truck 1.

The eight radar devices 21 to 28 can detect the relative positions between objects and the dump truck 1 over the entire peripheral area, which corresponds to 360°, of the dump truck 1 as the detection ranges. The eight radar devices 21 to 28 send relative position information, which represents the respective detected relative positions between the objects and the dump truck 1, to the controller 100. As described above, the plurality of (eight) radar devices 21 to 28 are provided on the vehicle body portion 2 and can detect objects that are present in the entire peripheral area of the vehicle body portion 2.

<Controller>

The controller 100 displays whether or not an object is present around the dump truck 1 on the bird's-eye image 200 with the imaging devices 11 to 16 and the radar devices 21 to 28, and informs an operator of the presence of the object as necessary. As illustrated in FIG. 3, the controller 100 includes a bird's-eye image synthesis unit 110, a camera image switching/visual point changing unit 120, a display controlling unit 130, a monitor image creating unit 140, an object information collecting unit 210, and an object processing unit 220.

As illustrated in FIG. 3, the bird's-eye image synthesis unit 110 is connected to the imaging devices 11 to 16. The bird's-eye image synthesis unit 110 receives a plurality of image information (first to fifth image information) that is created when the respective imaging devices 11 to 16 take images. Further, the bird's-eye image synthesis unit 110 creates the bird's-eye image 200, which includes the entire peripheral area of the dump truck 1, by synthesizing images that correspond to the plurality of received image information. Specifically, the bird's-eye image synthesis unit 110 creates bird's-eye image information, which represents the bird's-eye image 200 formed by projecting a plurality of images onto a predetermined projection plane, by the coordinate conversion of the plurality of image information.

The camera image switching/visual point changing unit 120 is connected to the imaging devices 11 to 16 as illustrated in FIG. 3, and switches images that are taken by the respective imaging devices 11 to 16 and displayed on the screen of the monitor 50 together with the bird's-eye image 200 according to obstacle detection results and the like that are obtained from the radar devices 21 to 28. Further, the camera image switching/visual point changing unit 120 converts the image information, which is acquired by the respective imaging devices 11 to 16, into image information that is obtained from a visual point corresponding to the upper infinity.

As illustrated in FIG. 3, the display controlling unit 130 is connected to the camera image switching/visual point changing unit 120, the monitor image creating unit 140, and the object processing unit 220. The display controlling unit 130 sends object position information, which is used to synthesize and display the position information of objects acquired by the radar devices 21 to 28 on the bird's-eye image 200 formed by synthesizing the image information acquired by the respective imaging devices 11 to 16, to the camera image switching/visual point changing unit 120 and the monitor image creating unit 140.

As illustrated in FIG. 3, the monitor image creating unit 140 is connected to the bird's-eye image synthesis unit 110, the camera image switching/visual point changing unit 120, and the display controlling unit 130. The monitor image creating unit 140 creates an image, which includes the position of an object, on the bird's-eye image 200 on the basis of the image information, which is acquired by the imaging devices 11 to 16 and the radar devices 21 to 28 and corresponds to the entire peripheral area of the dump truck 1, and the object position information. This image is displayed on the monitor 50.

As illustrated in FIG. 3, the object information collecting unit 210 is connected to the radar devices 21 to 28 and the object processing unit 220. The object information collecting unit 210 receives object detection results, which correspond to the respective detection ranges, from the radar devices 21 to 28 and sends the object detection results to the object processing unit 220.

As illustrated in FIG. 3, the object processing unit 220 is connected to the object information collecting unit 210 and the display controlling unit 130. The object processing unit 220 sends object position information, which is received from the object information collecting unit 210, to the display controlling unit 130.

In this embodiment, as illustrated in FIG. 4, the imaging devices 11 to 16 are disposed on the front surface and side surfaces of the upper deck 2b and below the vessel 4. Further, the controller 100 creates the bird's-eye image 200, which is illustrated in FIG. 5, by synthesizing the first to sixth image information, which are acquired when the imaging devices 11 to 16 take images, and displays the bird's-eye image 200 on the monitor 50 that is disposed in front of the driver's seat 31 in the cab 3. At this time, the monitor 50 displays an image such as the bird's-eye image 200 according to the control of the controller 100. The first to sixth image information, which correspond to the first to sixth areas 11C to 16C imaged by the imaging devices 11 to 16, are synthesized by the controller 100, so that the bird's-eye image 200 is obtained. The periphery monitoring system 10 displays this bird's-eye image 200 on the monitor 50. For this reason, an operator of the dump truck 1 can monitor the entire range, which corresponds to 360° around the dump truck 1, by visually recognizing the bird's-eye image 200 displayed on the monitor 50. Next, the bird's-eye image will be described.

<Bird's-Eye Image>

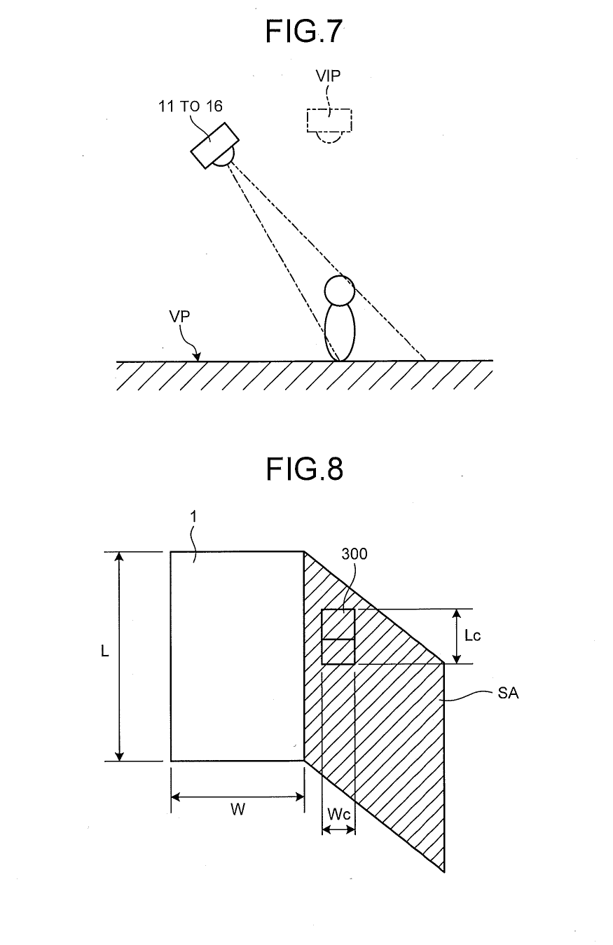

FIG. 7 is a view illustrating an image converting method using a virtual projection plane VP. The controller 100 forms the bird's-eye image 200 of the peripheral area of the dump truck 1 on the basis of a plurality of images that are represented by a plurality of first to six image information. Specifically, the controller 100 performs the coordinate conversion of the first to six image information by using predetermined conversion information. The conversion information is information that represents the correspondence between the position coordinates of each of pixels of input images and the position coordinates of each of pixels of an output image. In this embodiment, the input images are images that are taken by the imaging devices 11 to 16 and are images corresponding to the first to six image information. The output image is the bird's-eye image 200 that is displayed on the monitor 50.

The controller 100 converts the images, which are taken by the imaging devices 11 to 16, into an image, which is seen from a predetermined virtual visual point positioned above the dump truck 1, by using the conversion information. Specifically, as illustrated in FIG. 7, the images taken by the imaging devices 11 to 16 are converted into an image, which is seen from a virtual visual point VIP positioned above the dump truck 1, by being projected onto a predetermined virtual projection plane VP. The conversion information represents the virtual projection plane VP. The converted image is a bird's-eye image displayed on the monitor 50. The controller 100 forms the bird's-eye image 200 of the peripheral areas of the dump truck 1 by projecting the plurality of first to six image information, which are acquired from the plurality of imaging devices 11 to 16, onto the predetermined virtual projection plane VP in order to synthesize the image information.

As illustrated in FIG. 5, the peripheral areas of the dump truck 1, which are imaged by the respective imaging devices 11 to 16, overlap each other at first to six overlapping areas OA1 to OA6. The controller 100 displays images, which correspond to two information of the first to six image information obtained from two adjacent imaging devices of the imaging devices 11 to 16, on the bird's-eye image 200 so that the images overlap each other at the respective first to six overlapping areas OA1 to OA6.

Specifically, the controller 100 displays an image of the first image information obtained from the first imaging device 11 and an image of the second image information obtained from the second imaging device 12 so that the images overlap each other at the first overlapping area OA1. Further, the controller 100 displays the image of the first image information obtained from the first imaging device 11 and an image of the third image information obtained from the third imaging device 13 so that the images overlap each other at the second overlapping area OA2. Furthermore, the controller 100 displays the image of the second image information obtained from the second imaging device 12 and an image of the fourth image information obtained from the fourth imaging device 14 so that the images overlap each other at the third overlapping area OA3. Moreover, the controller 100 displays the image of the third image information obtained from the third imaging device 13 and an image of the fifth image information obtained from the fifth imaging device 15 so that the images overlap each other at the fourth overlapping area OA4. Further, the controller 100 displays the image of the fourth image information obtained from the fourth imaging device 14 and an image of the sixth image information obtained from the sixth imaging device 16 so that the images overlap each other at the fifth overlapping area OA5. Furthermore, the controller 100 displays the image of the fifth image information obtained from the fifth imaging device 15 and the image of the sixth image information obtained from the sixth imaging device 16 so that the images overlap each other at the sixth overlapping area OA6.

When two image information overlap each other and are synthesized at the first to six overlapping areas OA1 to OA6 in this way, values, which are obtained by multiplying the values of the first to six image information by synthesis ratios, are added. The synthesis ratios are values corresponding to the first to six image information, and are stored by the controller 100. For example, the synthesis ratio of the first image information is 0.5, the synthesis ratio of the second image information is 0.5, and the like, that is, a synthesis ratio is determined for each of the first to six image information. Since the synthesis ratios are used, a plurality of image information are averaged and displayed at the first to six overlapping areas OA1 to OA6. As a result, the rapid changes of a color and contrast are suppressed, so that the controller 100 can form a natural bird's-eye image 200. The controller 100 creates synthesis image information, which represents the bird's-eye image synthesized as described above, and outputs the synthesis image information to the monitor 50.

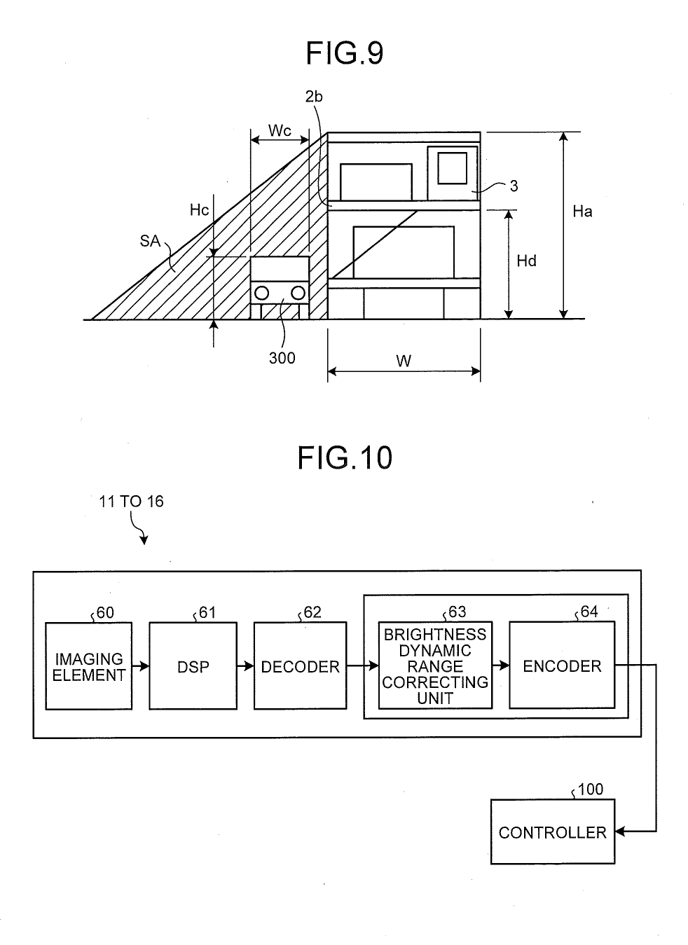

FIG. 8 is a plan view illustrating a relation between the dump truck and a vehicle that is present around the dump truck. FIG. 9 is a front view illustrating the relation between the dump truck and the vehicle that is present around the dump truck. The dump truck 1, which is used in a mine, is a very large vehicle of which the amount of objects is about 80 t (ton) to 400 t (ton), the overall length L is about 8 m (meter) to 15 m (meter), the width W is about 5 m (meter) to 10 m (meter), and the overall height Ha is about 5 m (meter) to 8 m. For this reason, an area where a shadow is formed is formed around the dump truck 1 according to the direction of the sun (an area denoted by SA of FIGS. 3 and 4 is appropriately referred to as a shadow area SA in the following description). The shadow area SA depends on the altitude of the sun. However, since the overall height Ha of the dump truck 1 is particularly large, the size of the shadow area SA may exceed 10 m (meter) to the outside of the dump truck 1 in some cases.

A vehicle (service car) 300, such as a car in which an operator of the dump truck 1 gets and which is used by the operator when the operator moves to the dump truck 1 or a car or a small truck that makes the rounds in a mine, is used in the mine. Since the vehicle 300 is a car or a small truck, the vehicle 300 has an overall length Lc of about 5 m (meter), a width We of about 2 m (meter), and an overall height Hc of about 2 m (meter). As described above, the vehicle 300 is significantly smaller than the dump truck 1. The size of the shadow area SA substantially exceeds 10 m (meter) to the outside of the dump truck 1 as described above. Accordingly, when the vehicle 300 enters the shadow area SA, the vehicle 300 is completely hidden in the shadow area SA.

In general, there is the intensity of illumination substantially corresponding to diffused reflection or the like even in the area of a shadow. However, since the shadow area SA of the dump truck 1 is very large, light caused by diffused reflection or the like becomes very little. As a result, the intensity of illumination in the shadow area SA is reduced. For this reason, the bird's-eye image 200, which is obtained by imaging the vehicle 300 present in the shadow area SA with the imaging devices 11 to 16, has a large difference in the contrast of light and shade (black and white) (for example, tens of thousands lux or more). As a result, since the vehicle 300 present in the shadow area SA is surrounded by the dark (black) portion of the bird's-eye image 200, so that there is a possibility that the vehicle 300 is not displayed on the bird's-eye image 200. As a result, there is a possibility that the operator of the dump truck 1 may not recognize the vehicle 300 that is approaching the dump truck 1. Particularly, when the vehicle 300 is present on the side opposite to the cab 3, which is disposed on the upper deck 2b, with respect to the center axis of the dump truck 1 in the width direction or on the rear side of the dump truck 1 as illustrated in FIG. 3, the vehicle 300 is present at the blind spot of the operator who gets in the cab 3. Accordingly, it is necessary to allow the operator to reliably and visually recognize the vehicle 300, which is present at the blind spot of the operator, by the bird's-eye image 200.

A possibility that the vehicle 300 is present at a place in a mine where the dump truck 1 is present is high. Further, since the dump truck 1 itself moves in a mine while forming the shadow area SA, the place of the shadow area SA also changes from hour to hour. Furthermore, since the overall height of the dump truck 1 is changed when the vessel 4 is moved up and down, the range of the shadow area SA also significantly changes. For this reason, a situation around the dump truck 1 needs to be capable of being reliably taken in a situation by the bird's-eye image 200 in the dump truck 1, which is used in a mine, even in the environment where a difference in the contrast of light and shade is large.

Moreover, since a difference in the intensity of illumination between a sunny spot and a shady spot is very large at a place where sunlight is very strong, such as immediately below the equator or near the equator, a difference in the contrast of light and shade (black and white) of the bird's-eye image 200 significantly appears at such a place. Accordingly, the vehicle 300 present in the shadow area SA becomes more difficult to see. Since relatively many mines are present immediately below the equator or near the equator, there is a large request for visually recognizing the vehicle 300, which is present around the dump truck 1, by the bird's-eye image 200 in the periphery monitoring system 10 that is used for the dump truck 1 used in a mine.

In order to be capable of visually recognizing the vehicle 300, which is present around the dump truck 1, by the bird's-eye image 200, wide dynamic range (WDR) cameras are used as the imaging devices 11 to 16 in this embodiment. A wide dynamic range camera is a camera that has a function capable of adjusting the entire portion so that the entire portion can be visually recognized thoroughly, by correcting a dark portion into a bright portion while maintaining a bright portion at a visually recognizable level.

The first imaging device 11 illustrated in FIG. 2 is a camera that can image the front side of the vehicle body portion 2, and corresponds to a front wide dynamic range camera. The second imaging device 12 is a camera that can image the side (right side) and oblique front side of the vehicle body portion 2, and corresponds to a first side wide dynamic range camera (first right wide dynamic range camera). The second imaging device 12 is a camera that can image the side (left side) and oblique front side of the vehicle body portion 2, and corresponds to a first side wide dynamic range camera (first left wide dynamic range camera). The fourth imaging device 14 is a camera that can image the side (right side) and oblique rear side of the vehicle body portion 2, and corresponds to a second side wide dynamic range camera (second right wide dynamic range camera). The fifth imaging device 15 is a camera that can image the side (left side) and oblique rear side of the vehicle body portion 2, and corresponds to a second side wide dynamic range camera (second left wide dynamic range camera). The sixth imaging device 16 is a camera that can image the public relations of the vehicle body portion 2, and corresponds to a rear wide dynamic range camera.

FIG. 10 is a view illustrating an example of an imaging device to which a wide dynamic range camera is applied. Each of the imaging devices 11 to 16 includes an imaging element 60 such as a CCD, a DSP (Digital Signal Processor) 61, a decoder (video decoder) 62, a brightness dynamic range correcting unit 63, and an encoder (video encoder) 64. The brightness dynamic range correcting unit 63 and the encoder 64 are realized by, for example, an image processing IC (Integrated Circuit) 64.

The information on the image, which is taken by the imaging element 60, is converted into a digital signal by an AD (Analog Digital) converter and the digital signal is then input to the DSP 61. The DSP 61 processes the input digital signal of the information on the image, and then outputs the processed digital signal to the decoder 62. The decoder 62 decodes the processed signal, which is input from the DSP 61, and then outputs the decoded signal to the brightness dynamic range correcting unit 63. The brightness dynamic range correcting unit 63 performs brightness correction, more specifically, high dynamic range synthesis processing of the input signal of the image. The high dynamic range synthesis processing is processing for converting an original image having very high contrast, that is, an actual image, which is taken by the imaging element 60, into an image of which the contrast is reduced so as to be a contrast of about 1000:1. The brightness dynamic range correcting unit 63 outputs the signal of the image, which has been subjected to the high dynamic range synthesis processing, to the encoder 64. The encoder 64 encodes the input signal, and outputs the encoded signal to the controller 100. Signals that are output from the imaging devices 11 to 16, that is, signals that are output from the encoders 64 are the first to six image information.

The imaging devices 11 to 16 can correct a dark portion, such as a portion becoming the shadow of the dump truck 1, into a bright portion while maintaining a bright portion at a visually recognizable level by using wide dynamic range cameras as the imaging devices 11 to 16. For this reason, the images, which are taken by the imaging devices 11 to 16, do not easily cause under-exposure and over-exposure, and become images that are more easily understood as a whole. Accordingly, the periphery monitoring system 10, which includes the imaging devices 11 to 16, can display the bird's-eye image 200, from which an object such as a vehicle 300 present in the shadow area SA of the dump truck 1 is easily and visually recognized, on the monitor 50. When the periphery monitoring system 10 monitors the periphery of the dump truck 1 by using the images taken by the imaging devices 11 to 16 as described above, the periphery monitoring system 10 can display an object, which is present around the dump truck 1, on the image (for example, the bird's-eye image 200 in this embodiment) even in the environment where a difference in the contrast of light and shade is large. As a result, the operator of the dump truck 1 can reliably and visually recognize the periphery of the dump truck 1, particularly, an object such as a vehicle 300, which is present in the shadow area SA, regardless of the environment.

Since the periphery monitoring system 10 can create the bird's-eye image 200, which reliably displays an object present around the dump truck 1, as described above even in the environment where a difference in the contrast of light and shade is large, the periphery monitoring system 10 can allow the operator to reliably and visually recognize the vehicle 300, which is present at the blind spot of the operator, by the bird's-eye image 200. Accordingly, the periphery monitoring system 10 is very effective when monitoring the periphery of the above-mentioned very large dump truck 1 that is used in a mine. That is, in the large dump truck 1 which may form a very large shadow area SA and moves while forming the shadow area SA by oneself and of which the shadow area SA is significantly changed when the vessel 4 is moved up and down and the area forming the blind spot is large, the periphery monitoring system 10 creates the bird's-eye image 200, which reliably displays an object present around the dump truck 1, and can provide accurate information on the periphery of the dump truck 1 to the operator of the dump truck 1. Further, as for the dump truck 1 that operates at a place where a difference in the intensity of illumination between a sunny spot and a shady spot is very large, such as immediately below the equator, the periphery monitoring system 10 can provide accurate information on the periphery of the dump truck 1 to the operator of the dump truck 1.

Meanwhile, the sixth imaging device 16 is disposed below the vessel 4 above an axle housing that connects two rear wheels 6 and 6. As described above, the sixth imaging device 16 is disposed in the vehicle body portion 2 of the dump truck 1. Furthermore, since the vessel 4 overhangs toward the rear side of the dump truck 1, a shadow is apt to be formed below the vessel 4. That is, the sixth imaging device 16 is disposed at a position where the shadow area SA is apt to be formed. For this reason, the sixth imaging device 16 has very many opportunities for imaging the shadow area SA. Accordingly, it is preferable that the dump truck 1 include at least the sixth imaging device 16 and use a wide dynamic range camera as the sixth imaging device.

<Imaging Ranges of the Respective Imaging Devices>

As illustrated in FIG. 2, the dump truck 1 includes the first imaging device 11, the second imaging device 12, the third imaging device 13, the fourth imaging device 14, and the fifth imaging device 15 that are disposed on the upper deck 2b, and the sixth imaging device 16 that is disposed below the vessel 4 at the rear end of the frame 2f. Particularly, the second and third imaging devices 12 and 13 cover areas between the left and right sides and the oblique front left and right sides of the vehicle body portion 2 of the dump truck 1 as imageable areas. Moreover, the fourth and fifth imaging devices 14 and 15 cover areas between the oblique rear left and right sides and the left and right sides of the vehicle body portion 2 of the dump truck 1 as imageable areas. According to this, the controller 100 can create the bird's-eye image 200, which covers the entire peripheral area of the dump truck 1, in conjunction with the first image information and the sixth image information, which are imaged and acquired by the first and sixth imaging devices 11 and 16, and monitor the periphery of the dump truck 1.

Further, in this embodiment, the imaging devices 11 to 16, which are adjacent to each other, are disposed so that the first to sixth areas 11C to 16C, which are areas that can be imaged by the respective imaging devices 11 to 16, overlap each other at the portions adjacent to each other as illustrated in FIG. 5. If the controller 100 is provided with connecting cables at the overlapping portions of the first to sixth areas 11C to 16C, which can be imaged by the respective imaging devices 11 to 16, the controller 100 can monitor the entire peripheral area, which corresponds to 360°, of the dump truck 1 in plan view. Meanwhile, the connecting cables for connecting the first to sixth areas 11C to 16C, which are adjacent to each other, of the bird's-eye image 200 can be set at arbitrary positions in the overlapping ranges of the first to sixth areas 11C to 16C. Next, imaging ranges of the imaging devices 11 to 16 in the height direction will be described.

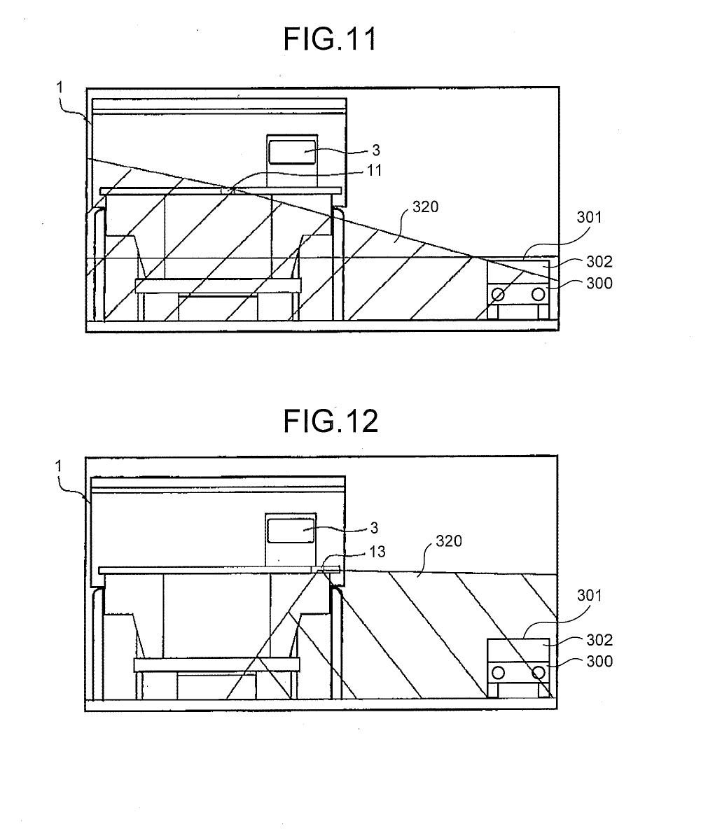

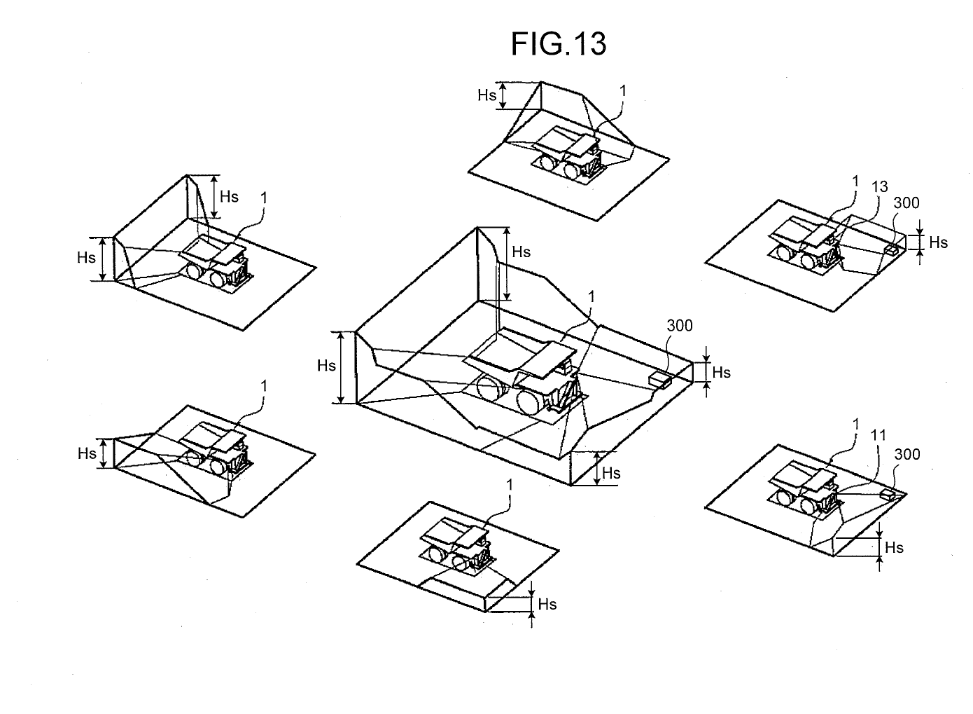

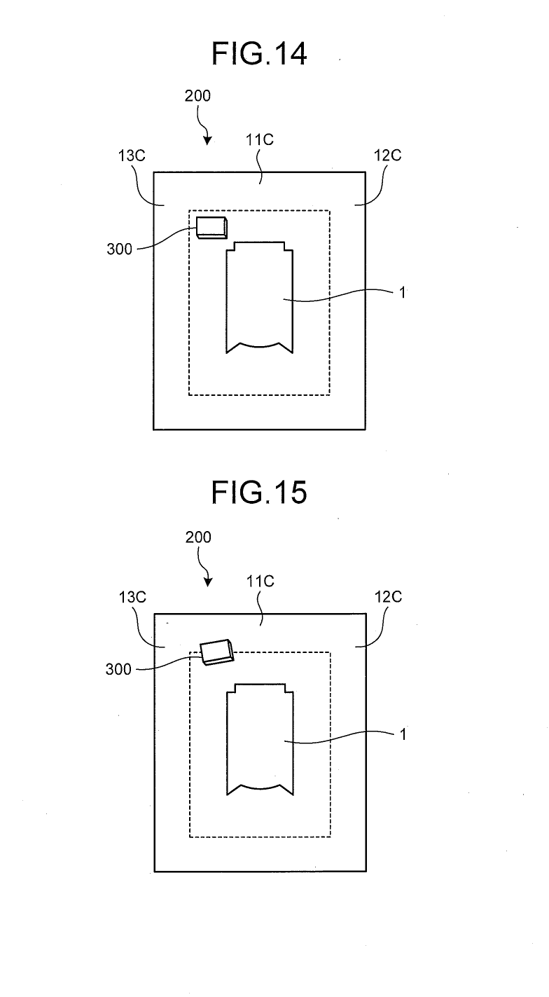

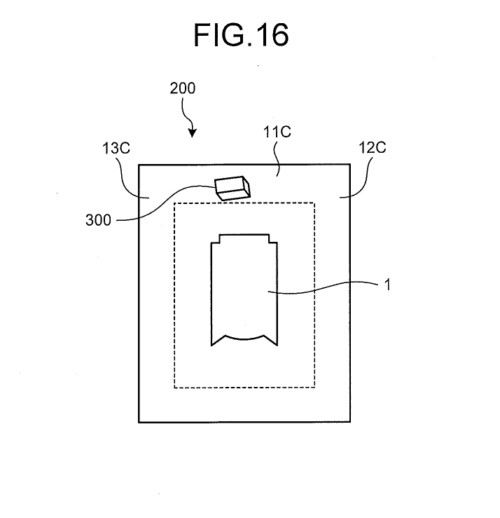

FIGS. 11 to 13 are views illustrating imaging ranges of the imaging devices of the periphery monitoring system according to this embodiment in the height direction. FIGS. 14 to 16 are views illustrating cases where a vehicle moves around the dump truck. Three-dimensional imaging ranges of the respective imaging devices 11 to 16 on the entire peripheral area of the dump truck 1 are illustrated in FIG. 13. The imaging ranges of the respective imaging devices 11 to 16 in the height direction within a range of a predetermined distance around the dump truck 1 are illustrated in this embodiment.

In order to reliably display an object (for example, a vehicle), which is present around the dump truck 1 (for example, within a range of 10 m (meter) around the dump truck 1), on the bird's-eye image 200, for example, the imaging device 11 may be disposed so that a part of the vehicle 300 is included in an imaging range 320 of the imaging device 11 as illustrated in FIG. 11. The other imaging devices 12 to 16 are the same as described above. When a vehicle 300 is present near the periphery of the imaging range on the front side of the dump truck 1 in the embodiment illustrated in FIG. 11, a roof 301 of the vehicle 300 gets out of the imaging range 320 of the first imaging device 11 in the state illustrated in FIG. 11. For this reason, the first imaging device 11 images the lower side from a window 302 of the vehicle 300, so that the bird's-eye image 200 formed on the basis of this imaged image information displays the lower side of the window 302 of the vehicle 300. As a result, there is a possibility that the operator of the dump truck 1, which sees this bird's-eye image 200, may not recognize the vehicle 300 since only a part of the vehicle 300 in the height direction is displayed.

Accordingly, in this embodiment, the respective imaging devices 11 to 16 are disposed so that the dump truck 1 allows the entire object (for example, a vehicle 300) present around the dump truck 1 to be displayed on the bird's-eye image 200 and allows an imaging range of the half or more (for example, 1.5 m (meter)) of the height of the upper deck 2b (for example, 3 m (meter)) in the height direction to be ensured. That is, in the case of an extra large vehicle such as the dump truck 1 that is used in a mine, it is difficult to visually recognize an object such as a vehicle 300 that is present below the upper deck 2b on which the cab 3 is installed when seen from the operator getting in the cab 3. For this reason, in order to allow the periphery monitoring system 10 to check an object that is present around the dump truck 1, it is necessary to allow an object, which is present at a position lower than the upper deck 2b from the ground, to be reliably recognized over the entire peripheral area of the dump truck 1.

In this embodiment, the imaging devices are disposed so that the height Hs of at least one imaging range of all the imaging ranges of the respective adjacent imaging devices in the horizontal direction is equal to or larger than a size that includes the entire object (for example, a vehicle 300) at the boundary portions (or overlapping portions) of the bird's-eye image 200, which is obtained by synthesizing image information imaged and acquired by adjacent imaging devices among the imaging devices 11 to 16. Further, in this embodiment, at least one of two adjacent imaging devices is disposed so that the imaging range in the height direction becomes a height corresponding to the half or more of the height of the upper deck 2b. As a result, since an object, which is present at a position lower than the upper deck 2b, can be in the imaging range of one of the imaging devices, which are adjacent to each other, among the respective imaging devices 11 to 16 as illustrated in FIG. 12, it is possible to reliably display the entire object on the bird's-eye image 200.

Specifically, even when, for example, the vehicle 300 serving as an object moves around the dump truck 1 to the first area 11C from the third area 13C so as to cross the boundary portion of the imaging range of each of the imaging devices 11 to 16 as illustrated in FIGS. 14 to 16, the periphery monitoring system 10 can display the entire vehicle 300 on the bird's-eye image 200. Meanwhile, it is preferable that an alpha blending technique, which averages and displays the overlapping portions of the boundary portions of the image corresponding to the first to six image information, be used when the bird's-eye image 200 is created by the synthesis of the first to six image information acquired by the respective imaging devices 11 to 16. According to this, it is possible to avoid the disappearance of an object at the boundary portions of the bird's-eye image 200 even when the object moves so as to cross the boundary portions of the images corresponding to the first to six image information.

<Modification>

In the above-mentioned embodiment, the periphery monitoring system 10 has created the bird's-eye image 200 on the basis of image information that is imaged and acquired by the imaging devices 11 to 16. However, the periphery monitoring system 10 is not limited to this embodiment. As described above, the dump truck 1 has the poorest visibility on the rear side and the range of the shadow area SA is significantly changed when the vessel 4 is moved up and down. The periphery monitoring system 10 may use, for example, only the sixth imaging device 16 that is disposed below the vessel 4 of the dump truck 1, and may use a high dynamic range camera as the sixth imaging device 16 in order to monitor the rear side of the dump truck 1. That is, the sixth imaging device 16, which is formed of a high dynamic range camera, may be used as a back monitor of the dump truck 1. According to this, the periphery monitoring system 10 can create an image on which vehicles or other objects present on the rear side of the dump truck 1 are displayed even in the environment where a difference in the contrast of light and shade is large, and can display the image on the monitor 50.

Meanwhile, it is preferable that six imaging devices 11 to 16 be used and wide dynamic range cameras be used as all these imaging devices when the entire peripheral area of the peripheral area of the dump truck 1 is monitored. According to this, it is possible to obtain the bird's-eye image 2 on which vehicles or other objects present around the dump truck 1 over the entire peripheral area of the dump truck 1 are displayed even in the environment where a difference in the contrast of light and shade is large.

This embodiment and the modification thereof have been described above, but elements that can be easily supposed by those skilled in the art and substantially the same elements are included in the above-mentioned components. In addition, the above-mentioned components may be appropriately combined with each other. Further, the components may be variously omitted, substituted, or modified without departing from the scope of this embodiment. The dump trucks according to this embodiment and the modification of this embodiment may have a large difference in the contrast of light and shade between a shady portion and a sunny spot portion due to the shadows that are formed by the dump trucks. For this reason, a dump truck used in a mine will be described above as an example in the above-mentioned embodiment and the modification of the embodiment. However, the dump truck is not limited to a dump truck used in a mine, and may be a dump truck that can be used in a construction site such as a dam.

### REFERENCE SIGNS LIST

1 DUMP TRUCK
2 VEHICLE BODY PORTION
2a LOWER DECK
2b UPPER DECK
2f FRAME
3 CAB
3a PILLAR
4 VESSEL
4F FLANGE PORTION
5 FRONT WHEEL
6 REAR WHEEL
10 PERIPHERY MONITORING SYSTEM
11, 12, 13, 14, 15, 16 IMAGING DEVICES
21, 22, 23, 24, 25, 26, 27, 28 RADAR DEVICES
31 DRIVER'S SEAT
50 MONITOR
60 IMAGING ELEMENT
61 DSP
62 DECODER
63 BRIGHTNESS DYNAMIC RANGE CORRECTING UNIT
64 ENCODER
100 CONTROLLER
110 BIRD'S-EYE IMAGE SYNTHESIS UNIT
120 CAMERA IMAGE SWITCHING/VISUAL POINT CHANGING UNIT
130 DISPLAY CONTROLLING UNIT
140 MONITOR IMAGE CREATING UNIT
200 BIRD'S-EYE IMAGE
210 OBJECT INFORMATION COLLECTING UNIT
220 OBJECT PROCESSING UNIT
300 VEHICLE
SA SHADOW AREA

1. A dump truck comprising:
a vehicle body portion that includes an upper deck on which a cab is disposed and a frame which is disposed in a longitudinal direction;
a vessel that is disposed above the frame; and
a rear wide dynamic range camera that is disposed below the vessel at a rear end of the frame and images a rear side of the vehicle body portion.

2. The dump truck according to claim 1, further comprising:
a front wide dynamic range camera that is disposed on a front portion of the upper deck and images a front side of the vehicle body portion;
side wide dynamic range cameras that are disposed on left and right side portions of the upper deck, respectively, and image areas between an oblique front side and the rear side of the vehicle body portion; and
a monitoring control device that monitors a periphery of the vehicle body portion by using a bird's-eye image formed by combination of images obtained by the rear wide dynamic range camera, the front wide dynamic range camera, and the respective side wide dynamic range cameras.

3. The dump truck according to claim 2,
wherein the side wide dynamic range cameras include a first side wide dynamic range camera that images the oblique front side of the vehicle body portion, and a second side wide dynamic range camera that images an oblique rear side of the vehicle body portion.

4. The dump truck according to claim 1, further comprising:
a plurality of radar devices that are provided on the vehicle body portion and detect objects present in an entire peripheral range of the vehicle body portion.

5. A dump truck comprising:
a vehicle body portion that includes an upper deck on which a cab is disposed and a frame which is disposed in a longitudinal direction;
a vessel that is disposed above the frame;
a rear wide dynamic range camera that is disposed below the vessel at a rear end of the frame and images a rear side of the vehicle body portion;
a front wide dynamic range camera that is disposed on a front portion of the upper deck and images a front side of the vehicle body portion;
side wide dynamic range cameras that are disposed on left and right side portions of the upper deck, respectively, and image areas between an oblique front side and the rear side of the vehicle body portion;
a monitoring control device that monitors a periphery of the vehicle body portion by using a bird's-eye image formed by combination of images obtained by the rear wide dynamic range camera, the front wide dynamic range camera, and the respective side wide dynamic range cameras; and
a monitor that is disposed in the cab and displays the bird's-eye image.
